(19) United States
(12) Patent Application Publication
(10) Pub. No.: US 2026/0086571 A1
(43) Pub. Date: Mar. 26, 2026

(54) METHODS, CONTROL SYSTEMS AND LAWN MOWERS TO MOW A PREDEFINED AREA

(71) Applicant: Greenworks (Jiangsu) Co., Ltd., Changzhou (CN)

(72) Inventors: Andre Lundkvist, Habo (SE); Lucas Magnusson, Jonkoping (SE)

(21) Appl. No.: 19/408,441

(22) Filed: Dec. 4, 2025

Related U.S. Application Data
(63) Continuation of application No. PCT/CN2023/099077, filed on Jun. 8, 2023.

(51) Int. Cl. G05D 1/648; G05D 1/247; G05D 105/15; G05D 107/20

(52) U.S. Cl. CPC G05D 1/6484; G05D 1/247; G05D 2105/15; G05D 2107/23

(57) ABSTRACT

A method performed by a control system for controlling a lawn mower to mow a predefined area, the method comprises: instructing the lawn mower to move substantially straight forward in a first direction for a first distance; instructing the lawn mower to turn a first angle in relation to the first direction); instructing the lawn mower to move substantially straight forward in a second direction for a second distance; instructing the lawn mower to turn a second angle in relation to the second direction; instructing the lawn mower to move substantially straight forward in a third direction for the first distance; instructing the lawn mower to turn a third angle in relation to the third direction; instructing the lawn mower to move substantially straight forward in a fourth direction for a third distance; instructing the lawn mower to turn a fourth angle in relation to the fourth direction.

### CROSS REFERENCE TO RELATED APPLICATIONS

The present application is a Continuation Application of PCT Application No. PCT/CN2023/099077 filed on Jun. 8, 2023, the contents of which are incorporated herein by reference in their entirety.

### TECHNICAL FIELD

The present disclosure relates generally to methods, control systems and lawn mowers to mow a predefined area.

### BACKGROUND

Autonomous lawn mowers are becoming more and more widely used and can be used on a variety of lawns such as gardens, football fields, golf courses, etc. An autonomous lawn mower is a mower that can automatically perform mowing without manual operation.

In prior art, the lawn mower usually uses a random mowing mechanism, as shown in FIG. 1. An autonomous lawn mower 100 mows a grass 200 randomly. Actually, random mowing has become industry standard. For example, the direction of the lawn mower's motion is randomly selected, and when the lawn mower hits a boundary, a turning angle is randomly selected, then the lawn mower moves in the new direction to mow the grass. After a period of time, the entire lawn is partially or completely mowed.

The disadvantage of random mowing is that, because of the uncertainty of the mowing route, it takes the lawn mower to work for a longer time to mow the entire lawn, and there is no guarantee that the lawn will be mowed 100%. Therefore, there is a need for autonomous lawn mowers to perform a more efficient mowing method.

Systematic mowing is a more efficient mowing method for autonomous lawn mowers. Systematic mowing refers to controlling the lawn mower to follow a predefined route to cut the grass, rather than randomly selecting a route. However, for systematic mowing, it is necessary to consider that the mowing route should not overlap too much, otherwise the autonomous lawn mower will mow in the same route repeatedly, resulting in the grass of the lawn being cut unevenly and showing obvious mowing traces.

Therefore, there is a need to provide an efficient mowing method to the autonomous lawn mower that allows the lawn mower to efficiently mow the entire lawn while cutting evenly and without leaving obvious mowing traces.

### SUMMARY

It is an object of the invention to address at least some of the problems and issues outlined above. It is an object of embodiments of the invention to provide an efficient mowing solution for autonomous lawn mower. It is another object of embodiments of the invention to provide a mowing solution for autonomous lawn mower, so that the lawn mower mows the grass evenly without leaving obvious mowing traces. It is possible to achieve one or more of these objects and possibly others by using methods, control systems and lawn mowers as defined in the attached independent claims.

In a first aspect of the disclosure there is provided a method performed by a control system for controlling a lawn mower to mow a predefined area. The mowing width of the lawn mower is X1, and the method comprises: instructing the lawn mower to move substantially straight forward in a first direction for a first distance; instructing the lawn mower to turn a first angle in relation to the first direction; instructing the lawn mower to move substantially straight forward in a second direction for a second distance, such that the lawn mower moves through N*X1 in the direction perpendicular to the first direction; instructing the lawn mower to turn a second angle in relation to the second direction, such that the first angle and the second angle in total substantially equals to 180°; instructing the lawn mower to move substantially straight forward in a third direction for the first distance; instructing the lawn mower to turn a third angle in relation to the third direction; instructing the lawn mower to move substantially straight forward in a fourth direction for a third distance, such that the lawn mower moves through (N−1)*X1 plus an offset in the direction perpendicular to the first direction, the offset is less than X1; instructing the lawn mower to turn a fourth angle in relation to the fourth direction, so that the lawn mower is in the first direction after turning.

In a second aspect of the disclosure there is provided a control system for controlling a lawn mower to mow a predefined area. The mowing width of the lawn mower is X1, the control system comprises a processing circuitry and a memory, the memory containing instructions executable by the processing circuitry. The control system is operative for: instructing the lawn mower to move substantially straight forward in a first direction for a first distance; instructing the lawn mower to turn a first angle in relation to the first direction; instructing the lawn mower to move substantially straight forward in a second direction for a second distance, such that the lawn mower moves through N*X1 in the direction perpendicular to the first direction; instructing the lawn mower to turn a second angle in relation to the second direction, such that the first angle and the second angle in total substantially equals to 180°; instructing the lawn mower to move substantially straight forward in a third direction for the first distance; instructing the lawn mower to turn a third angle in relation to the third direction; instructing the lawn mower to move substantially straight forward in a fourth direction for a third distance, such that the lawn mower moves through (N−1)*X1 plus an offset in the direction perpendicular to the first direction, the offset is less than X1; instructing the lawn mower to turn a fourth angle in relation to the fourth direction, so that the lawn mower is in the first direction after turning.

In a third aspect of the disclosure that is provided a lawn mower which comprises the control system in the embodiment above.

### BRIEF DESCRIPTION OF DRAWINGS

The invention is now described, by way of example, with reference to the accompanying drawings, in which:

FIG. 1 schematically shows random mowing in prior art.

FIG. 2 shows a flow chart for the method performed by a control system for controlling the lawn mower, according to possible embodiments.

FIG. 3 schematically shows the control system and mowing width of the lawn mower, according to possible embodiments.

FIG. 4 schematically shows mowing routes of the lawn mower, according to possible embodiments.

FIG. 5 schematically shows mowing routes of the lawn mower, according to possible embodiments.

FIG. 6 shows mowing routes on a lawn, according to possible embodiments.

FIG. 7 schematically shows communication between the lawn mower and an external device, according to possible embodiments.

FIG. 8 schematically shows the control system in detail, according to possible embodiments.

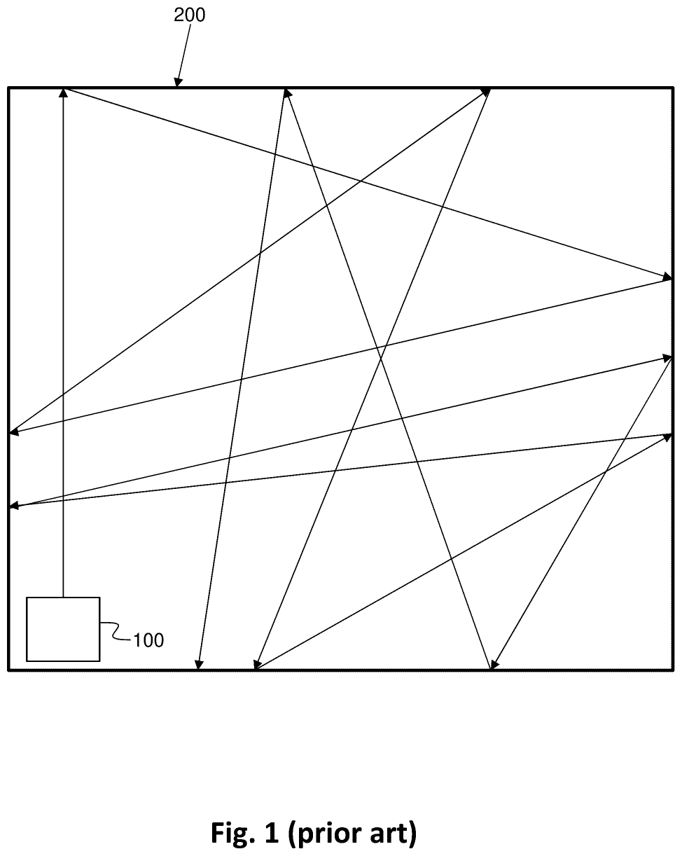

### DETAILED DESCRIPTION

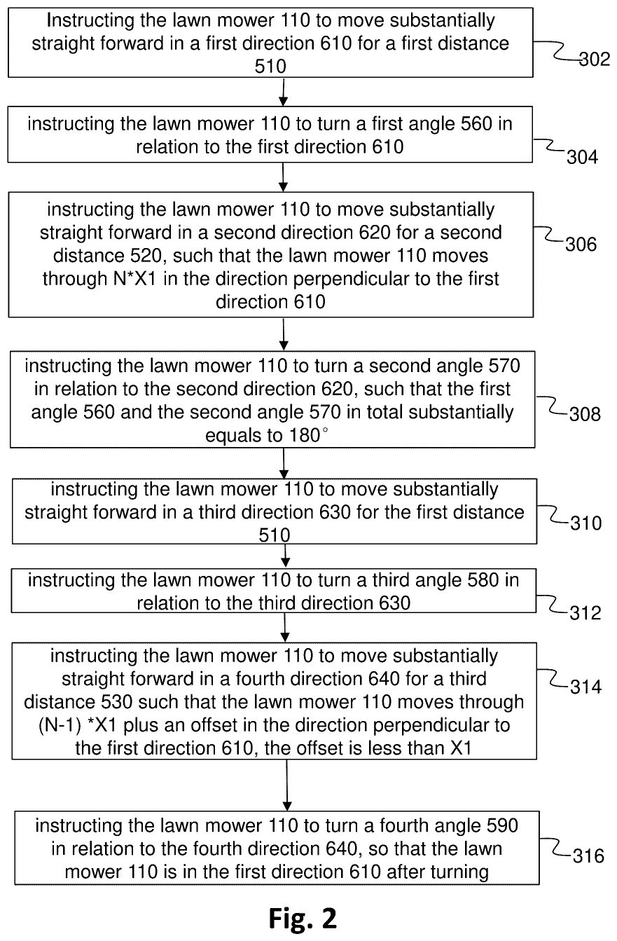

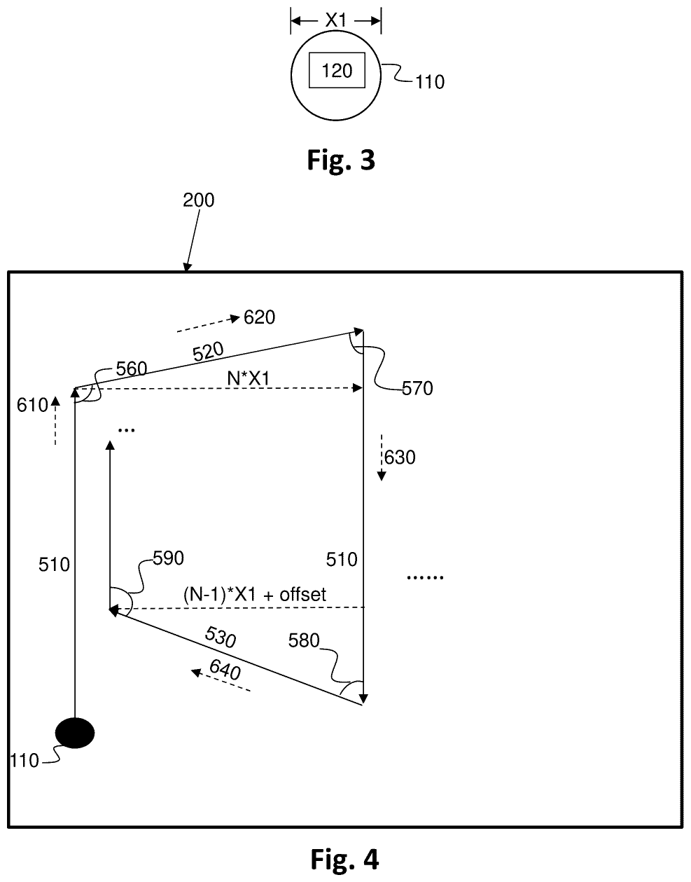

FIG. 2, in conjunction with FIGS. 3, 4, show a method performed by a control system 120 for controlling a lawn mower 110 to mow a predefined area 200.

Lawn mower 110 is an autonomous device utilizing one or more revolving blades or a reel to cut a grass surface to a desired height. The lawn mower 110 can also be called a robotic lawn mower.

As shown in FIG. 3, a control system 120 can be used to control the behavior of the lawn mower 110. The control system 120 can send instructions to the lawn mower 110 so that the lawn mower 110 operates accordingly. The control system 120 can be installed on the lawn mower 110, as shown in FIG. 3; it can also be arranged remotely to the lawn mower 110, and controls the lawn mower 110 by wireless communication. FIG. 3 also shows a mowing width of the lawn mower 110. The mowing width of the lawn mower 110 is X1. When the lawn mower 110 moves straightly forward and mows, a mowing line is generated. X1 is also the width of the mowing line.

The predefined area 200 is the target grass which will be mowed by the lawn mower 110. The predefined area 200 can be any shape, e.g., a rectangular, as shown in FIG. 4. It can also be irregular shape. The predefined area 200 is defined by boundaries.

According to an embodiment, a method is performed by the control system 120 for controlling the lawn mower 110 to mow the predefined area 200. The mowing width of the lawn mower 110 is X1. The method comprises: instructing 302 the lawn mower 110 to move substantially straight forward in a first direction 610 for a first distance 510; instructing 304 the lawn mower 110 to turn a first angle 560 in relation to the first direction 610; instructing 306 the lawn mower 110 to move substantially straight forward in a second direction 620 for a second distance 520, such that the lawn mower 110 moves through N*X1 in the direction perpendicular to the first direction 610; instructing 308 the lawn mower 110 to turn a second angle 570 in relation to the second direction 620, such that the first angle 560 and the second angle 570 in total substantially equals to 180°; instructing 310 the lawn mower 110 to move substantially straight forward in a third direction 630 for the first distance 510; instructing 312 the lawn mower 110 to turn a third angle 580 in relation to the third direction 630; instructing 314 the lawn mower 110 to move substantially straight forward in a fourth direction 640 for a third distance 530, such that the lawn mower 110 moves through (N−1) *X1 plus an offset in the direction perpendicular to the first direction 610, the offset is less than X1; instructing 316 the lawn mower 110 to turn a fourth angle 590 in relation to the fourth direction 640, so that the lawn mower 110 is in the first direction 610 after turning.

In this method, the control system 120 instructs all the behavior of the lawn mower 110. The lawn mower 110 firstly is instructed to move and mow substantially straight forward in the direction 610 for a first distance 510 in the step 302. Being substantially straight forward means that the lawn mower 110 may have some deviation when moving straight forward, but the deviation is within a reasonable range.

When finishing this, the lawn mower 110 is instructed to turn a first angle 560 to a second direction 620 in the step 304. Then the lawn mower 110 is instructed to move substantially straight forward in the second direction 620 for a second distance 520 in the step 306. When moving the second distance 520, the lawn mower 110 actually moves N*X1 in the direction perpendicular to the first direction 610, as shown in FIG. 4. By doing this, the lawn mower 110 does not go back directly parallel to the mowing line which was just mowed. Instead, the lawn mower 110 turns to the second direction 620 and mows in this direction.

In the following step 308, the lawn mower 110 is instructed to turn a second angle 570 so that it turns to the third direction. The first angle 560 and the second angle 570 in total substantially equal to 180°, which means the third direction 630 is substantially parallel to the first direction 610, however with 180° difference. In the step 310, the lawn mower 110 is instructed to continue moving straightly forward in the third direction 630 for the first distance 510, which is the same distance as in the first direction 610.

In the step 312, the lawn mower 110 is instructed to turn a third angle 580 so that the lawn mower 110 is in the fourth direction 640 after turning. In the step 314, the lawn mower 110 is instructed to move straightly forward in the third distance 530 in the fourth direction 640, so that the lawn mower 110 actually moves through (N−1)*X1 plus an offset in the direction perpendicular to the first direction 610, the offset is less than X1. By doing this, in the direction perpendicular to the first direction 610, the lawn mower 110 is instructed to move a distance which is slightly shorter than N*X1, so that the lawn mower 110 would not move back to the line of the first distance 510, so that the line of the first distance 510 will not be mowed repeatedly.

In the step 316, the lawn mower 110 is instructed to turn a fourth angle 590, so that the lawn mower 110 is in the first direction 610 again. In other words, the third angle 580 and the fourth angle 590 in total equals to 180°. However, as explained above, the position of the lawn mower 110 is not in the line of the first direction 510.

The first angle 560, the second angle 570, the third angle 580 and the fourth angle 590 are settled so that the lawn mower 110 substantially turns clockwise in the four turns. The first angle 560, the second angle 570, the third angle 580 and the fourth angle 590 can also be settled so that the lawn mower 110 substantially turns counterclockwise in the four turns. After turning the fourth angle 590, the lawn mower 110 substantially moves and mows an unclosed trapezoid shape.

By this embodiment, the control system 120 instructs the lawn mower 110 to mow the predefined area 200 in an efficient and systematic way. The behavior of the lawn mower 110 is totally controllable and predictable.

According to another embodiment, the method further comprises repeating the steps in the embodiment above after the lawn mower 110 turning the fourth angle 590.

By this embodiment, the lawn mower 110 is instructed to move and mow “trapezoids” continuously. However, since the lawn mower 110 moves and mows unclosed trapezoids, the finishing position of each trapezoid is different. Therefore, the repeating mowing lines are avoided, and fewer mowing traces are generated.

According to another embodiment, the N is predefined or determined on the fly.

N indicates the “width” or “height” of a trapezoid. When the N is determined on the fly, it can be determined randomly, or based on the actual situation of the predefined area 200, e.g., the dimension of the predefined area 200. With proper determination of the N, the mowing traces are further reduced. For example, the N may differ significantly with each trapezoid, so that repeating mowing lines are reduced.

According to another embodiment, the offset is predefined or determined on the fly.

The offset indicates the size of the “opening” of the trapezoid. Similar to N, the offset can be predefined or determined on the fly. When determined on the fly, the offset can be e.g., determined randomly or based on actual situation of the predefined area 200.

According to another embodiment, the first distance 510 is predefined or determined on the fly based on the dimension of the predefined area 200.

The first distance 510 can be predefined, e.g., when the predefined area 200 is a regular shape, as shown in FIG. 4. The first distance 510 can also be determined on the fly, e.g., when the predefined area 200 is an irregular shape, so that the first distance 510 can be different for each unclosed trapezoid. These two examples are not limitations to the embodiment, the first distance 510 can be predefined or determined on the fly in all kinds of predefined areas 200.

According to anther embodiment, the first angle 560, the second angle 570, the third angle 580 and/or the fourth angle 590 are predefined or determined on the fly based on the dimension of the predefined area 200, the first angle 560, the second angle 570, the third angle 580 and/or the fourth angle 590 are within the range between 1° and 180° respectively.

The first angle 560, the second angle 570, the third angle 580 and/or the fourth angle 590 define the shape of the trapezoid. Each of the angles is within the range between 1° and 180°, as long as the first angle 560 and the second angle 570 is 180° in total, and the third angle 580 and the fourth angle 590 is 180° in total.

For example, when mowing a football field, each angle can be predefined 90°, so that the lawn mower 110 moves and mows unclosed squares, which fits best for the shape of the football field. Meanwhile, the mowing traces are parallel. In another example, when mowing the predefined area 200 with an irregular shape, the angles can be determined on the fly based on the dimension of the predefined area 200, so as to follow the irregular shape.

According to another embodiment, when instructing the lawn mower 110 to turn, instructing the lawn mower 110 to move along a curve 700 when turning.

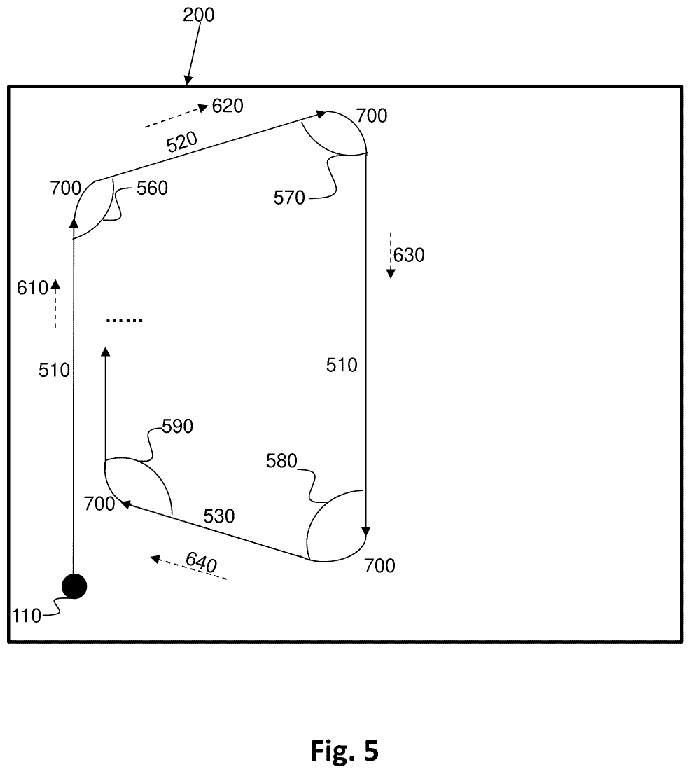

Referring to FIG. 5, the lawn mower 110 is instructed to move curves 700 when turning the angles 560-590. By turning the curves 700, it is easier for the lawn mower 110 to turn. Sharp turnings are avoided. Furthermore, since the route and length of the curves 700 can be flexible and can vary for each turn, repeated mowing lines are further reduced and mowing traces are decreased.

According to another embodiment, the method further comprises determining that the lawn mower 110 is to move over a boundary of the predefined area 200, decreasing the N so that the lawn mower 110 is moving within boundaries of the predefined area 200.

By this embodiment, it can be guaranteed that the lawn mower 110 is mowing within the predefined area 200 all the time.

According to another embodiment, the lawn mower 110 is operative for mowing the grass on different heights when moving in different directions.

In some scenarios, different mowing height are required in different directions so that the mowed grass has a desired appearance.

According to another embodiment, the method further comprises receiving position correction information sent from an external device 300; instructing the lawn mower 110 to correct its position according to the received position correction information.

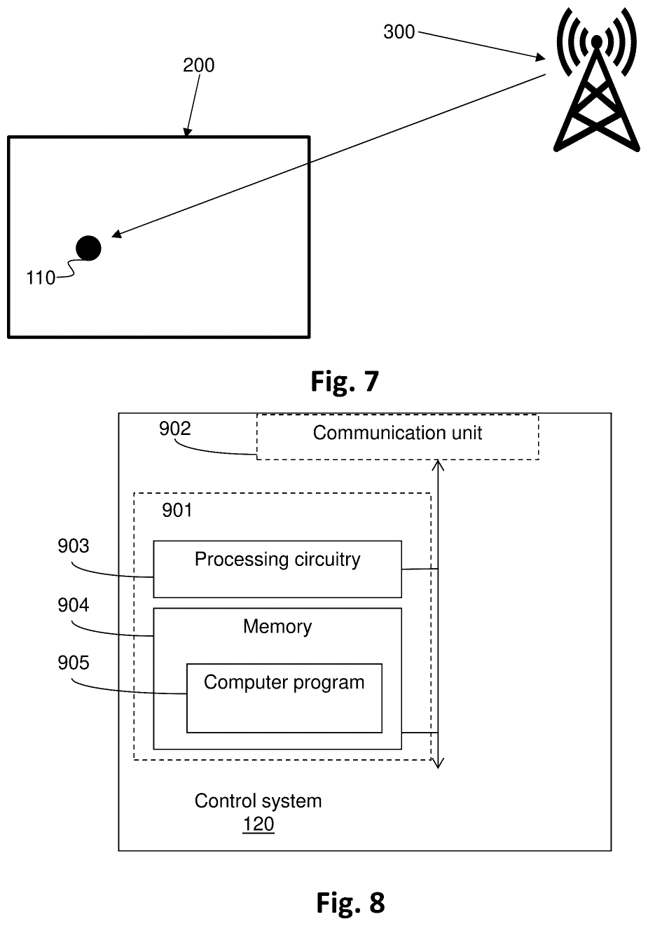

The position of the lawn mower 110 is critical when instructing the lawn mower 110 to move. Therefore, referring to FIG. 7, the control system 120 can receive position correction information from an external device 300 and instructing the lawn mower 110 to correct its position accordingly. The external device 300 can be a base station, a NodeB, an eNodeB, a gNodeB, etc, as long as it can provide position correction information. Furthermore, real time kinematic (RTK) positioning can be used to obtain accurate position correction information.

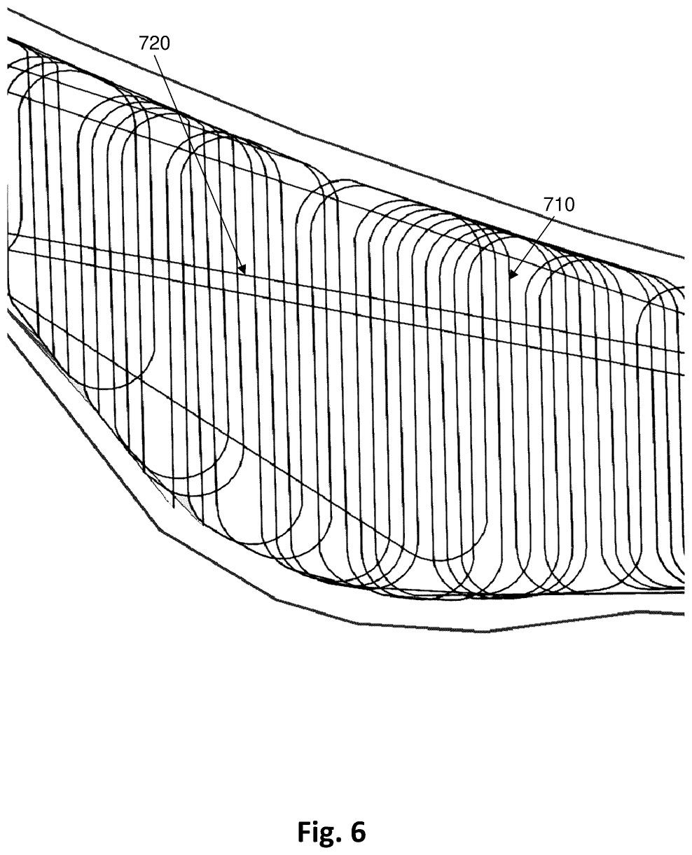

Referring to FIG. 6, an embodiment of mowing routes for a predefined area is shown. The predefined area is an irregular shape. In this embodiment, the first distances, the N and the angles are determined based on the dimension of the predefined area. When turning, the lawn mower turns along curves. It can be seen that the lawn mower follows the shape of the predefined area and mows efficiently without many repeating mowing lines. In the embodiment, the lawn mower mows the predefined area when it moves. In an alternative embodiment, the lawn mower can also move without mowing. For example, when the lawn mower moves in the line 710, it mows while moving; when the lawn mower moves in the line 720, it moves without mowing.

According to another embodiment, referring to FIGS. 2-8, a control system 120 for controlling a lawn mower 110 to mow a predefined area 200, the mowing width of the lawn mower 110 is X1, the control system 120 comprises a processing circuitry 903 and a memory 904, the memory 904 containing instructions executable by the processing circuitry 903. The control system 120 is operative for: instructing the lawn mower 110 to move substantially straight forward in a first direction 610 for a first distance 510; instructing the lawn mower 110 to turn a first angle 560 in relation to the first direction 610; instructing the lawn mower 110 to move substantially straight forward in a second direction 620 for a second distance 520, such that the lawn mower 110 moves through N*X1 in the direction perpendicular to the first direction 610; instructing the lawn mower 110 to turn a second angle 570 in relation to the second direction 620, such that the first angle 560 and the second angle 570 in total substantially equals to 180°; instructing the lawn mower 110 to move substantially straight forward in a third direction 630 for the first distance 510; instructing the lawn mower 110 to turn a third angle 580 in relation to the third direction 630; instructing the lawn mower 110 to move substantially straight forward in a fourth direction 640 for a third distance 530, such that the lawn mower 110 moves through N−1*X1 plus an offset in the direction perpendicular to the first direction 610, the offset is less than X1; instructing the lawn mower 110 to turn a fourth angle 590 in relation to the fourth direction 640, so that the lawn mower 110 is in the first direction 610 after turning.

According to other embodiments, the control system 120 is operative for perform the methods as defined above.

According to other embodiments, a lawn mower 110 is provided. The lawn mower 110 comprises the control systems 120 as defined above.

According to other embodiments, referring to FIG. 8, the control system 120 may further comprise a communication unit 902, which may be considered to comprise conventional means for wireless communication with other devices, such as a transceiver for wireless transmission and reception of signals. The instructions executable by said processing circuitry 903 may be arranged as a computer program 905 stored e.g. in said memory 904. The processing circuitry 903 and the memory 904 may be arranged in a sub-arrangement 901. The sub-arrangement 901 may be a micro-processor and adequate software and storage therefore, a Programmable Logic Device, PLD, or other electronic component(s)/processing circuit(s) configured to perform the methods mentioned above. The processing circuitry 903 may comprise one or more programmable processor, application-specific integrated circuits, field programmable gate arrays or combinations of these adapted to execute instructions.

The computer program 905 may be arranged such that when its instructions are run in the processing circuitry, they cause the control system 120 to perform the steps described in any of the described embodiments of the control system 120 and its method. The computer program 905 may be carried by a computer program product connectable to the processing circuitry 903. The computer program product may be the memory 904, or at least arranged in the memory. The memory 904 may be realized as for example a RAM (Random-access memory), ROM (Read-Only Memory) or an EEPROM (Electrical Erasable Programmable ROM). In some embodiments, a carrier may contain the computer program 905. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 904. Alternatively, the computer program may be stored on a server or any other entity to which the control system 120 has access via the communication unit 902. The computer program 905 may then be downloaded from the server into the memory 904.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a control system (120) for controlling a lawn mower (110) to mow a predefined area (200), the mowing width of the lawn mower (110) is X1, the method comprises:
instructing (302) the lawn mower (110) to move substantially straight forward in a first direction (610) for a first distance (510);
instructing (304) the lawn mower (110) to turn a first angle (560) in relation to the first direction (610);
instructing (306) the lawn mower (110) to move substantially straight forward in a second direction (620) for a second distance (520), such that the lawn mower (110) moves through N*X1 in the direction perpendicular to the first direction (610);
instructing (308) the lawn mower (110) to turn a second angle (570) in relation to the second direction (620), such that the first angle (560) and the second angle (570) in total substantially equals to 180°;
instructing (310) the lawn mower (110) to move substantially straight forward in a third direction (630) for the first distance (510);
instructing (312) the lawn mower (110) to turn a third angle (580) in relation to the third direction (630);
instructing (314) the lawn mower (110) to move substantially straight forward in a fourth direction (640) for a third distance (530), such that the lawn mower (110) moves through (N−1)*X1 plus an offset in the direction perpendicular to the first direction (610), the offset is less than X1;
instructing (316) the lawn mower (110) to turn a fourth angle (590) in relation to the fourth direction (640), so that the lawn mower (110) is in the first direction (610) after turning.

2. The method as claimed in claim 1, the method further comprises:
repeating the steps in claim 1 after the lawn mower (110) turning the fourth angle (590).

3. The method as claimed in claim 1, wherein the N is predefined or determined on the fly.

4. The method as claimed in claim 1, wherein the offset is predefined or determined on the fly.

5. The method as claimed in claim 1, wherein the first distance (510) is predefined or determined on the fly based on the dimension of the predefined area (200).

6. The method as claimed in claim 1, wherein the first angle (560), the second angle (570), the third angle (580) and/or the fourth angle (590) are predefined or determined on the fly based on the dimension of the predefined area (200), the first angle (560), the second angle (570), the third angle (580) and/or the fourth angle (590) are within the range between 1° and 180° respectively.

7. The method as claimed in claim 1, wherein, when instructing the lawn mower (110) to turn, instructing the lawn mower (100) to move along a curve (700) when turning.

8. The method as claimed in claim 1, wherein the method further comprises:
determining that the lawn mower (110) is to move over a boundary of the predefined area (200), decreasing the N so that the lawn mower (110) is moving within boundaries of the predefined area (200).

9. The method as claimed in claim 1, wherein the lawn mower (110) is operative for mowing the grass on different heights when moving in different directions.

10. The method as claimed in claim 1, the method further comprises:
receiving position correction information sent from an external device (300);
instructing the lawn mower (110) to correct its position according to the received position correction information.

11. A control system (120) for controlling a lawn mower (110) to mow a predefined area (200), the mowing width of the lawn mower (110) is X1, the control system (120) comprises a processing circuitry (903) and a memory (904), the memory (904) containing instructions executable by the processing circuitry (903), whereby the control system (120) is operative for:
instructing the lawn mower (110) to move substantially straight forward in a first direction (610) for a first distance (510);
instructing the lawn mower (110) to turn a first angle (560) in relation to the first direction (610);
instructing the lawn mower (110) to move substantially straight forward in a second direction (620) for a second distance (520), such that the lawn mower (110) moves through N*X1 in the direction perpendicular to the first direction (610);
instructing the lawn mower (110) to turn a second angle (570) in relation to the second direction (620), such that the first angle (560) and the second angle (570) in total substantially equals to 180°;
instructing the lawn mower (110) to move substantially straight forward in a third direction (630) for the first distance (510);
instructing the lawn mower (110) to turn a third angle (580) in relation to the third direction (630);
instructing the lawn mower (110) to move substantially straight forward in a fourth direction (640) for a third distance (530), such that the lawn mower (110) moves through (N−1)*X1 plus an offset in the direction perpendicular to the first direction (610), the offset is less than X1;
instructing the lawn mower (110) to turn a fourth angle (590) in relation to the fourth direction (640), so that the lawn mower (110) is in the first direction (610) after turning.

12. The control system (120) as claimed in claim 11, the control system (120) is further operative for repeating the operations in claim 11 after the lawn mower (110) turning the fourth angle (590).

13. A lawn mower (110) comprises the control system (120) claimed in claim 11.

14. A computer program (905) comprising instructions, which, when executed by a processing circuitry (903) of a control system (120), controlling a lawn mower (110) to mow a predefined area (200), the mowing width of the lawn mower (110) is X1, causes the control system (120) to perform methods as claimed in claim 1.

15. A carrier containing the computer program (905) according to claim 14, wherein the carrier is one of an electronic signal, an optical signal, a radio signal, an electric signal, or a computer readable storage medium.
